(19) United States
(12) Patent Application Publication
(10) Pub. No.: US 2002/0091582 A1
(43) Pub. Date: Jul. 11, 2002

(54) Systems and methods for e-commerce facilitation and implementation

(76) Inventors: John F. Palmer, Alpine, UT (US); Rick Davenport, North Salt Lake, UT (US); William Meyers, Huntsville, AR (US)

Correspondence Address: KIRTON & MCCONKIE, 1800 Eagle Gate Tower, 60 East South Tample, Salt Lake City, UT, 84111, US

(21) Appl. No.: 09/853,249

(22) Filed: May 11, 2001

Related U.S. Application Data
(60) Provisional application No. 60/203,556, filed on May 11, 2000.

(51) Int. Cl. G06F 17/60

(52) U.S. Cl. 705/26

(57) ABSTRACT

The present invention features a system that allows a merchant to create a web site from the embodiments of the present invention using a structure-template based software tool. The merchant then inputs information into the present invention and thereby automatically creates an index, with contact information, email capabilities, product listing and other information. At the same time, the merchant can generate product listings pages with photos, order forms with capabilities of linking related products and that can calculate totals, prices, shipping. The merchant can also generate a Web site search engine so customers can quickly find the products on the site they are looking for. The system has a fully customizable, easy-to use menu system, with everything password protected for security. The merchant may further create a Web site that automatically generates product listings with photos, along with detailed descriptions of the price, characteristics and attributes of each of the products. The three main pages are a product listings page, product information page and an order form page. All three pages function in a way that allows purchasers to easily order a product from a merchant, while at the same time customizing and supplementing their order.

### RELATED APPLICATION

This application claims priority to U.S. Provisional Patent Application Serial No. 60/203,556 filed on May 11, 2000.

### THE FIELD OF THE INVENTION

Some embodiments of the present invention relate to methods and software tools that enable merchants and vendors to create efficient and optimized electronic commerce (“eCommerce”) Web sites. Specifically, some embodiments of this invention allow merchants to design Web sites with streamlined purchasing and shopping capabilities. Further, some embodiments of the present invention provide a structure-based template comprising three main components that operate synergistically to create an efficient system for eCommerce shopping.

### BACKGROUND

Merchants desiring to do business through the internet need efficient, streamlined and optimized ways of making their products both available to purchasers and easy to order. In existing eCommerce Web sites, purchasers are unable to order products within two or three easy “clicks.” Purchasers often must go through a number of unnecessary links to find their product, only to have to back track through those pages if they desire to modify or supplement their order. Also, in existing Web sites, purchasers are unable to modify the characteristics or attributes of the product they wish to purchase from the order form itself. Purchasers must back track to the exact pages where the product is found and formulate a new order. Additionally, an order form page that enables a purchaser to link to products similar to those being purchased is unavailable in the prior art, but would be advantageous because quick and easy supplemental purchasing is often desired.

The prior art is also deficient because it does not offer Web sites with easy-to-use, quick-to-load capabilities. Much of the decision in choosing how to structurally and methodically create the site is left to the merchant, who is often unaware of how to create a system that maximizes efficiency for shoppers. Structure-based templates offer this type of optimization, however, no such structure-based templates currently exist. Rather, the prior art software tools are page-template based, which can lead to random, inefficient and unworkable methods for selling merchants' products. Thus, there remains a need for eCommerce Web site design tools with predefined structure that is optimized for eCommerce shopping.

### SUMMARY AND OBJECTS OF THE INVENTION

In light of the deficiencies in the above-described prior art designs for creating efficient and friendly online electronic commerce web sites, particularly for online shopping, the present invention seeks to overcome these deficiencies by eliminating the problems associated with prior art systems.

It is therefore an object of some of the preferred embodiments of the present invention to provide a software tool that overcomes the prior art deficiencies by making it possible to quickly create a fully customizable easy-to-navigate Internet electronic commerce Web site.

It is another object of some of the preferred embodiments of the present invention to provide a software tool for facilitating the creation of Web sites and pages based on stored structure-based templates that enable personalization and customization of the Web site and pages without the need for a user to change or write any software code, or to have programming knowledge or experience.

It is another object of some of the preferred embodiments of the present invention to provide a software tool that makes it possible to quickly create an easy-to-navigate Internet electronic commerce Web site having automatically created and/or generated features that the user may select in customizing a web site or web page.

It is still another object of some of the preferred embodiments of the present invention to provide a software tool that makes it possible to quickly create a fully customizable easy-to-navigate Internet electronic commerce Web site that is compatible with any computer having an Internet connection.

It is a further object of some of the preferred embodiments of the present invention to provide a full featured Internet business Web site having the ability to accept and process orders and inquiries from visitors.

It is a still further object of some of the preferred embodiments of the present invention to provide a structure-form based software tool that makes it possible to quickly create a fully customizable easy-to-navigate Internet electronic commerce Web site.

It is yet another object of some of the preferred embodiments of the present invention to provide a software tool that makes it possible to quickly create an easy-to-navigate Internet electronic commerce Web site for facilitating the creation of Web sites and pages by taking a web site creator through a series of views, each having one or more options/features, to enable the site creator to select from a plurality of options/features available for the web site layout, content and functionality.

These and other objects are accomplished by various embodiments of the invention. Some embodiments of the present invention overcome the deficiencies of the prior art because such embodiments provide merchants with an optimal method of conducting internet business and by providing merchants with a predefined structural-based template.

Some embodiments of the present invention provide systems and methods for enabling a merchant to create an eCommerce Web site that is efficient, easy-to-use and that streamlines site maintenance and use. Some embodiments include tools, which enables merchants to create a Web site that is capable of being easily modified and customized and that also has a pre-defined, optimized structure. Some embodiments of the present invention overcome the limitations of the prior art, which usually only allow merchants to build Web sites with no set structure and no regard to feasibility and efficiency.

Some embodiments of the present invention enable merchants to automatically create an eCommerce Web site with novel features and attributes. Merchants may automatically create a Web site with an index providing details about the merchant, contact information, product listing, and with email capabilities. Some embodiments allow a merchant to automatically generate product listings with photos. Other embodiments allow the merchant to generate order forms where customers can order products and that also immediately calculates total, taxes, shipping, etc. Even other embodiments of the present invention automatically create a Web site search engine so customers quickly find the products on the site for which they are looking.

Some embodiments of the present invention include an order form that allows for optional characteristics, such that when a purchaser has selected a product and is ready to order, they may from the order form page itself link to related products or modify and supplement their purchase. An important benefit of this order form feature is that it allows the purchaser to quickly modify the product and also quickly link products related to the product being purchased so that the purchaser may enhance and supplement the purchase. In accordance with another aspect of the invention, the system is structure-template based, or structure-form based, rather than page-template based. This is so the merchant may design the actual web pages with any look and feel he or she so desires, however, allows the merchant to not have to bother with the essential structure because it has been predefined to work optimally and quickly for eCommerce shopping. This embodiment assists the merchant in avoiding creating inefficient, uncoordinated Web sites.

Further embodiments of the present invention allow the merchant to select from a variety of different settings and to have the ability to modify the site to customize unique features of the Web site.

In accordance with still another embodiment of the present invention, the three main components of the system have synergy among each other so that each page streamlines the purchasing process. The embodiments of the invention accomplish such synergy by providing product pages with detailed descriptions of the product, prices, pictures and options all linked together. The product listing page has a link for every product page. The order form page has the enhanced and unique capability of linking to related products, modifying and supplementing a purchase.

Because embodiments of the present invention make it easy for merchants to access, create and modify, there is little need for merchants to systematize and organize the system on their own, with the potential for compromising efficiencies. Rather, the merchant simply needs to design the look and feel and leave the optimal purchasing process to the preferred embodiments of the present invention.

### BRIEF DESCRIPTION OF THE DRAWINGS

The foregoing and other objects and features of the present invention will become more fully apparent from the accompanying drawings when considered in conjunction with the following description and appended claims. Although the drawings depict only typical embodiments of the invention and are thus not to be deemed limiting of the invention's scope, the accompanying drawings help explain the invention in added detail.

FIG. 1 illustrates a web page displaying a list of all administrative functions of the web site;

FIG. 2 illustrates a web page displaying the functions of the product listing page;

FIG. 3 illustrates a web site function for displaying various product information;

FIG. 4 illustrates a web page displaying the functions of the order form page;

FIG. 5 illustrates slideshow maker of the present invention and available options;

FIG. 6 illustrates a web page featuring options for creating a new slideshow;

FIG. 7 illustrates a web page featuring options for creating a new tutorial page;

FIG. 8 illustrates a web page featuring various slideshow settings that are selectable by a user for creating and editing a slideshow;

FIG. 9 illustrates a web page featuring the edit slideshow page option and the various headlines that are selectable by a user;

FIG. 10 illustrates a web page featuring an edit slideshow page option of the specific headline;

FIG. 11 illustrates a web page featuring the introductory page of the custom form builder option wherein a user may select any number of fields to be included in the form;

FIG. 12 illustrates a web page featuring specific field properties for the form; and

FIG. 13 illustrates a web page featuring the edit form option of the slideshow maker.

### DETAILED DESCRIPTION OF THE PREFERRED EMBODIMENTS

The figures listed above are expressly incorporated as part of this detailed description.

It is emphasized that the present invention, as illustrated in the figures and description herein, can be embodied or performed in a wide variety of ways. Thus, neither the drawings nor the following more detailed description of the various embodiments of the system and method of the present invention limit the scope of the invention. The drawings and detailed description are merely representative of the particular embodiments of the invention; the substantive scope of the present invention is limited only by the appended claims.

The various embodiments of the invention will be best understood by reference to the drawings, wherein like elements are designated by like alphanumeric characters throughout. Moreover, it should be noted that because the present invention is computer-implemented, particular embodiments may range from computer executable instructions as part of computer readable media to hardware used to implement the processes herein described. Embodiments of the present invention also include combinations of hardware and computer executable instructions.

Further, whether the invention is described in terms of a method, a system, an application, a type of software, or as computer readable media having computer executable instructions stored thereon, the description is intended to include “instructions” such as program modules, routines, programs, objects, components, data structures, etc. that perform particular tasks within a computing environment. Executable instructions may comprise instructions and data which cause a general purpose computer, special purpose computer, or special purpose processing device to perform a certain function or group of functions.

In addition, computer readable media may comprise any available media which can be accessed by a general purpose or special purpose computer. By way of example and not limitation, such computer readable media includes any type of RAM (SDRAM, ESDRAM, etc.) or ROM (EPROM, EEPROM, FEPROM, EAROM, etc.) stored on any physical medium, including a computer chip, a server, or a disk. Disks can include optical storage devices (e.g., CD-ROMs or DVD-ROMs), magnetic storage devices (e.g., floppy disks, Zip® disks, or Bernoulli® cartridges), or any other medium that can be used to store the desired executable instructions or data fields and which can be accessed by a general purpose or special purpose computer. Combinations of any of the above-named media are also included within the scope of computer readable media.

While the invention has been described herein with reference to certain preferred embodiments, these embodiments have been presented by way of example only, and not to limit the scope of the invention.

The merchant creates a web site from the embodiments of the present invention using a structure-template based software tool (software tool). The merchant then inputs information into the present invention and thereby automatically creates an index, with contact information, email capabilities, product listing and other information. At the same time, the merchant can generate product listing pages with photos, order forms with capabilities of linking related products and that can calculate totals, prices, shipping. The merchant can also generate a Web site search engine so customers can quickly find the products on the site they are looking for. The system has a fully customizable, easy-to use menu system, with everything password protected for security. The merchant may further create a Web site that automatically generates product listings with photos, along with detailed descriptions of the price, characteristics and attributes of each of the products.

The three main pages are a product listing page, product information page and an order form page. All three pages function in a way that allows purchasers to easily order a product from a merchant, while at the same time customizing and supplementing their order. Once a purchaser is on merchant's web site and has selected a product, the purchaser may then go to the order form and purchase the product. The order form calculates order totals, taxes, and shipping. The order form has the unique capability of allowing the purchaser to change the attributes or characteristics of the product without having to restart the purchasing process. The order form has links to the product description pages and product listing pages that allows the purchaser to not only change the order from the order form, but also to link and see related products that might supplement the purchase.

The present invention features a computer system comprising a software tool that allows several users to create their own online electronic commerce web sites, and particularly their own online shopping web sites, or eStores, that are capable of interacting with one another. The software tool allows an eStore owner, or system user, to automatically generate images using input from one or several eStore owners, and upload the image into their eStore. This will allow eStore owners to create logos and backgrounds without using third party software. It also eliminates the need for the user to download the image to their computer and upload it to their eStore.

EStore owners can compress the images used by their site automatically. They are given a choice of image quality, and they choose the one they prefer. This allows eStore owners to compress images without the use of third party software. It also eliminates the need for the user to download the image to their computer, compress it, and upload it to their eStore.

Statistics showing hit counts, time of hits, and browser type will be kept for all pages, and can be viewed from an eStore administration panel.

Every page will have the option to add a short form that allows visitors to add their contact info into a newsletter list. The eStore owner can specify the instructions and title for the form. Every page will have the ability to turn this form on or off from an edit screen of that page.

The eStore owner will be able to compile various customer and informational lists, such as an email list, and send a message to everyone on that email list. Every message will have a line at the bottom allowing anyone who receives this message to remove themselves from the list. If a recipient opts out, they will automatically be removed from the mailing list as desired.

The software tool will generate javascript using input from other eStore owners. This will allow eStore owners to validate form input and create a mouseover button.

The software tool will also integrate with other online web sites, such as E-bay, to create and build useful informational pages. For example, a product list may be generated, or product statistics or user traffic may be gathered and monitored to create a statistics builder, etc. Traffic and other statistics, such as those that track hits on e-bay products, and traffic generated to the web site by those products, are very useful for eStore owners who use other sites, such as e-bay, to generate traffic to their eStore. They can also track what types of online listings are most effective for them.

The software tool will allow eStore owners to create affiliate programs for their eStore. The affiliate setup panel will be linked to from the eStore Administration menu. From the affiliate setup panel, the eStore owner can create new affiliate ID's, change percentages given to affiliates, and view affiliate accounts.

Thumbnail Galleries can be created that allow eStore visitors to view small images of products that link to the product page for that product.

The software tool will offer several design themes that will automatically be loaded onto an eStore.

The software tool will automatically track inventory and, if the eStore owner wishes, will notify customers and/or the eStore owner when an item is out of stock.

EStore owner can also specify how many links are in the left-hand navigation bar.

The software tool also comprises a slideshow maker. The slideshow maker allows eStore owners to create presentations that are linked together in a sequential order. Every page in the slideshow has a navigation bar on the left side. EStore owners can create major headings that are featured in the slideshow navigation bar that is standard throughout the slideshow. This allows for quick navigation through the slideshow. The slideshow creation panel consists of 5 pages. A main menu, a page for creating new pages, 2 pages for editing existing pages, and a page for reordering existing pages and changing the look of all pages.

The software tool further comprises a shopping cart/order form hybrid, where the order form has all products and options offered by the eStore, and automatically selects items added to the cart with the correct quantity and options from the cart. The orders are stored on a secure server and the eStore owner is notified by email when an order is received.

A subset of the eStore can be password protected. This is enabled/disabled from the edit panel for that page.

EStore owners can upload or delete any type of file or folder into an upload area linked to from the main menu. This allows them to move files over the Internet without knowing an FTP. It also allows them to have different entry pages with different domain names for a single eStore.

EStore owners can upload images into the navigation bar to be used as button links to other pages. EStore owners can enable a guest book that lets visitors leave comments, and displays those comments on a guest book page in the eStore. This is done by using the form builder. The software also allows auctions to be done on an eStore instead of having to go to an auction site. In addition, eStore owners can create master product pages that are copied into every eStore, update/remove/add master product pages on eStores, disable edit options for any page, track all sales made and charge merchants a percentage of all their sales, break the order form into pages organized by category, specify option drop down lists for products (shipping, handling, size, color, etc), which is done on the Add/Edit product screens, and track activity on what changes are being made to each eStore. Moreover, this list is searchable from the site.

The eStore main administration menu will feature a link to the slideshow menu. The slideshow menu will have three choices: “Create new slideshow page,” “Edit existing Slideshow Page,” and “Slideshow Settings.”

The “Create new slideshow page” will produce a page that takes input for the new page. The fields include, but are not limited to, the follwing: Page Headline, Page Text, Image Box, Image Alignment (left, right, center), Include page in Navigation Bar? (Yes/No), and Link Phrase if page is in Nav-Bar.

All new pages are added at the end of the existing slideshow. The “Edit existing slideshow page” will produce a page that lists all existing pages in the slideshow and the headline of each page. Each page listed will have a link that if clicked brings up the edit page for that page. The edit page is identical to the “Create new slideshow” page, except all fields are filled in with the existing information for that page. The “Slideshow Settings” page lists all existing pages by the headline for each page in the slideshow. They are ordered as they appear in the slideshow. Each page has a numbered text box that indicates it's order in the slideshow. The numbers can be changed to indicate a new order of pages. This page also has input for the following items: headline size, headline font, headline color, text size, text font, text color, link color, active link color, visited link color, and background image. Each item in the settings determines aspects of how the slideshow looks. If an image file is uploaded into the background image box, it will be displayed as the background image for the slideshow.

The software tool also comprises a custom form builder that allows the user to set up fields and values. This product allows eStore owners to create HTML forms that accept input from eStore visitors and send the information to the eStore owner via e-mail. The eStore owner can specify the size type of field that accepts the input, the name for each field, and the text displayed by the submit button.

From the main menu, the first page viewed asks how many fields will be included in the field, and the e-mail address to submit the contents of the form to.

The second page gives a box for a page introductory message, options for the number of fields specified on the first page, a box for a closing message name of the submit button, and name of the reset button. The options for each field are as follows: “name of field,” “is this field required,” “test preceding this field,” “type of field,” “text,” “text area,” radio,” “drop-down selection box,” “list of selections if field is a radio or drop-down selection,” “width for a text area field,” “height for a text area field,” “width for a text field,” and “name of field.” These are not to be considered exclusive.

The end of the page has a text input box for the name of the submit button. Also from the main menu, the edit page asks for number of fields to add to the current form, and the email address to submit the contents of the form to.

The second edit page is identical to the second form creation page, but each existing field is filled in with the previous settings, and each field has a checkbox by the name of the field that will delete that field if checked.

The software tool further comprises a downloadable order history. A user may click on “View Order History” to view orders that have been received since the secure setting was activated. If no order has been placed since the secure setting was chosen, no orders will be displayed. If there are orders in the secure area, they will be listed in the order they were received.

A link to the order history file “Download Order History” is shown at the bottom of the list. To download the file, the user may right-click on the Order History link and choose “Save Target As” from the pop-up menu. Some browsers will allow you to simply click on the link.

To view a specific order, the user may click on the order number, after which the user will be prompted for a username and password to gain access to the order. The username and password can be the same as the username/password for the eStore admin panel.

To remove an order stored in the secure area, click on “Remove Order Records” from the eStore admin menu. A list of all orders stored in the secure area will be displayed, with a checkbox by each one. Click in the checkbox for each order you want to delete from the secure area. When you have selected all of the orders you wish to delete, click on the “Remove Order Records” button.

The software product further comprises the ability for the user to utilize hidden product pages to create unlimited pages. These hidden product pages are hidden from the Listings Page. To enable or keep a product page from showing on the “View Listings” page and the Order Form, the user puts an asterisk (*) into the Listing ID for that product. This is useful to upload images that you want to reference using HTML elsewhere in your eStore. The eStore owner can also use hidden product pages to extend the number of Main pages. These pages must be linked to using HTML within the body of other pages, since they are not featured in the navigation bar.

The software tool further comprises the ability to create categories. Categories are optional on both the product listing page and order form. Category headings are added to the Listings page and the Order Form. A category heading is created by putting a “<>” (without quotes) into the price field of a product page. You must include a Listing ID, as the heading will be sorted on the Listings Page/Order Form according to the listing number. (If you are sorting by ID.) The text in the Headline field will be shown on the Listings Page and Order Form.

The software tool further comprises button images that use the same system as other images. These button images can be loaded onto the navigation bar in much the same way that images for Logo, Background, and product pages are loaded. On the “Change eStore Settings” page exists text boxes for the link phrase. Just below the link phrase input box is a button image upload box. The eStore owner may click on the browse button and select the image to be uploaded as the button for that page.

To remove an existing button, the user types “remove” in the image upload box, just as would be done to remove background images. Upon removal of the button image, the link phrase for that page will be displayed instead. It should be noted that each button will not automatically say what the link phrase does. The user must create a separate image for each button. Moreover, the user must still supply a link phrase for each page to be featured in the text links at the bottom of each page.

The software tool finally further comprises the ability to easily align logos that the eStore owner wishes to use on the web site. The last field in the “Change eStore Settings” page is the “Main Logo Alignment” field. This allows the user to change and align the logos. Logos can be aligned to the “left,” “right,” or “center.” The default setting is “left.” Each option is included in the drop down menu from which the user simply selects.

The embodiments described herein may be featured on a method in a computer system for creating an e-commerce Internet web site, wherein the method comprises the step of generating a series of customizable web pages on said web site using a structure-form based software tool. The method may further comprise the step of generating a product listings page, a product information page, an order form page, and/or a menu administration page. An index may also be created by the computer system to organize the information on said web site.

The present invention further features a computer-readable program product for creating an e-commerce Internet web site, wherein the computer program product comprises code that directs a computer to create a web site using a structure-form based software tool that allows a user to input information into a series of forms controlled by a customizable menu system. The code resides on a tangible medium.

The computer-readable program product further comprises code that directs a computer to generate a product listings page, a product information page, an order form page, an index page for organizing said web site, and a slideshow maker for executing presentations.

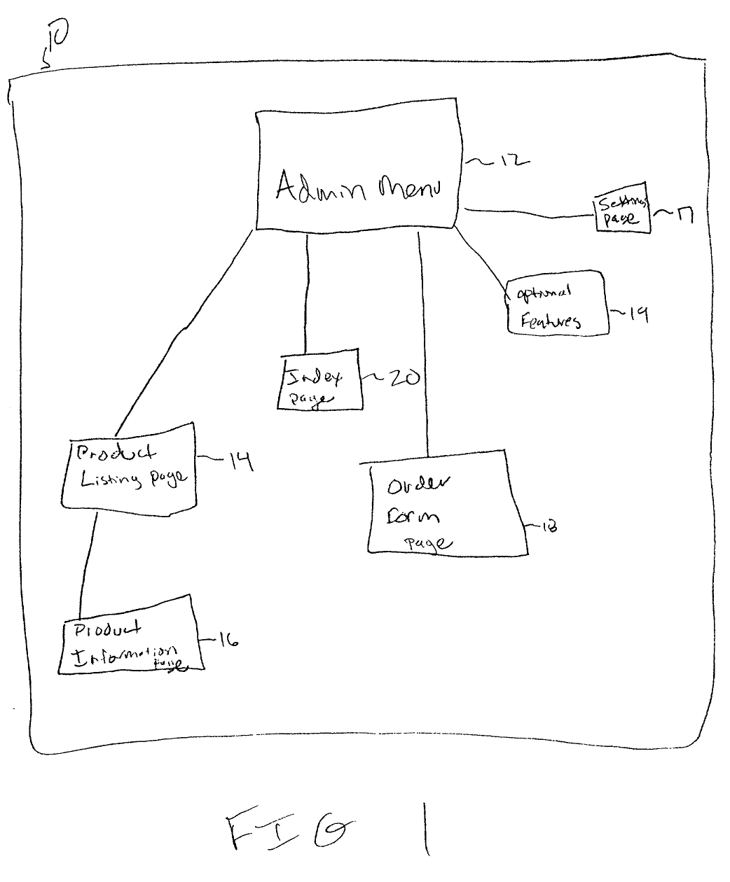

FIG. 1 illustrates an embodiment of the present invention displaying owner web site 10. Owner web site 10 displays a main administration menu 12. From this menu screen, owner has complete control over all functions of owner web site 10.

Features of administration menu 12 include products listing page 14, product information page 16, order form page 18, settings page 17, optional features page 19, and index control page 20. Settings page 17 includes control over all functions of owner web site 10 such as, but not limited to, changing of passwords, editing features, and modifying looks and operations not discussed elsewhere. Optional features 19 could include, but is not limited to, search capabilities, e-mail contacts, and other options known by those skilled in the art.

Through the use of index control page 20, a user can modify the headlines, the description, the logo graphic, and the background. The logo graphic and background images can be uploaded from user computer to owner web site 10. Changes to the logo graphic and background image can be applied to appear on all other main pages automatically, except the products listing page 14. A user may choose to use a different smaller logo or page layout and design o products listing page 14 than the one used on other main pages.

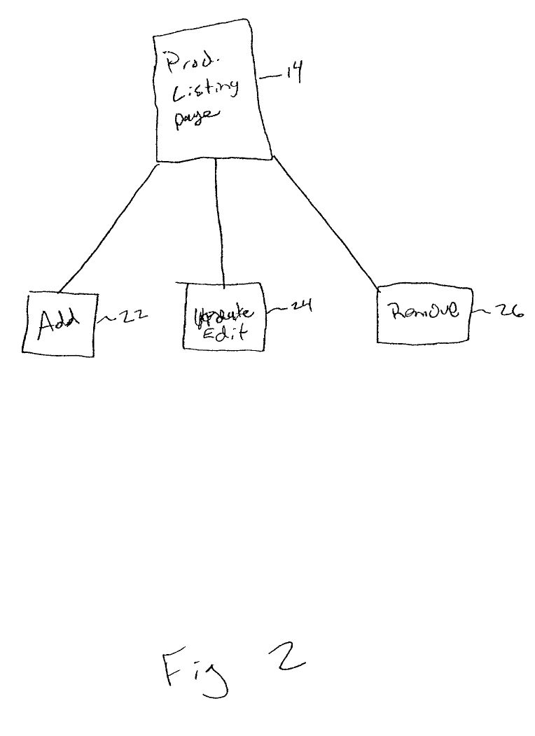

Through use of administration menu 12, user can access features such as products listing page 14. Functions of products listing page 14 include the ability of the user to add 22 new product listings to owner web site 10. User can select to sort products by category or other information about the product. Additionally, a user may add photos and contact e-mail information. As further shown in FIG. 2, a user may edit 24 product listings already displayed in owner web site 10. Furthermore, the user may remove 26 product listings so they are no longer displayed on product listing page 14.

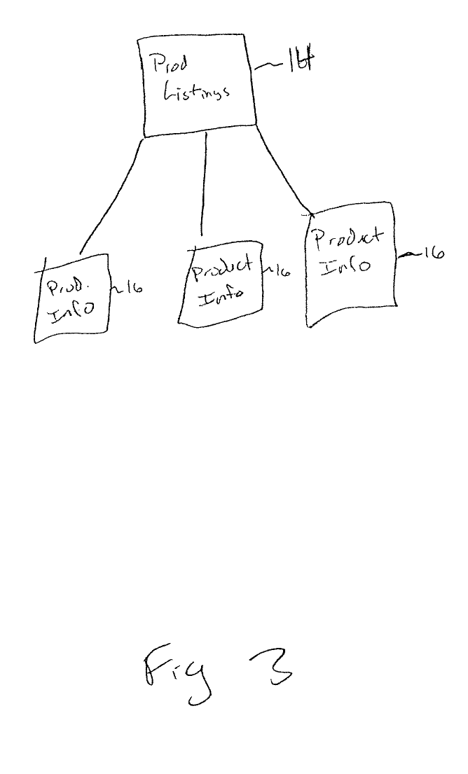

FIG. 3 is an embodiment of the present invention wherein products listing page 14 displays a brief description of all products or listings in owner web site 10. An Internet visitor can click on the brief description of an item in order to view product information page 16. Product information page 16 shows a full description of the listing along with photos and other product information. As an example, but not limited to, product information page 16 displays headlines, listing price, listing number, listing description, and contact e-mail of the agent or person handling the listing. Each product displays a separate product information page 16.

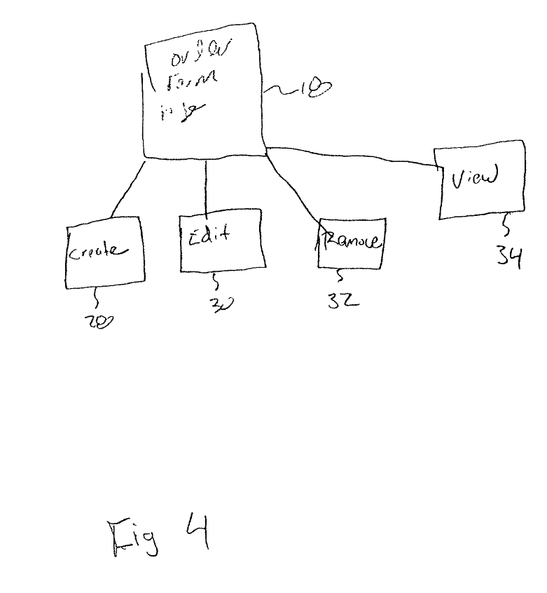

FIG. 4 illustrates an additional feature of administration menu 12. An order form page 18 can be displayed to allow user to create 28 an order form 18 for products listed in owner web site 10. Additional features include editing 30 of order form 18 settings to control how order form 18 looks and responds. Furthermore, users may view 34 order form 18. Order form 18 may be viewed in “unsecure” or “secure” mode and is intended as a quick way to view changes to order form 18. The user is also provided the ability to remove 32 any order form 18 within owner web site 10.

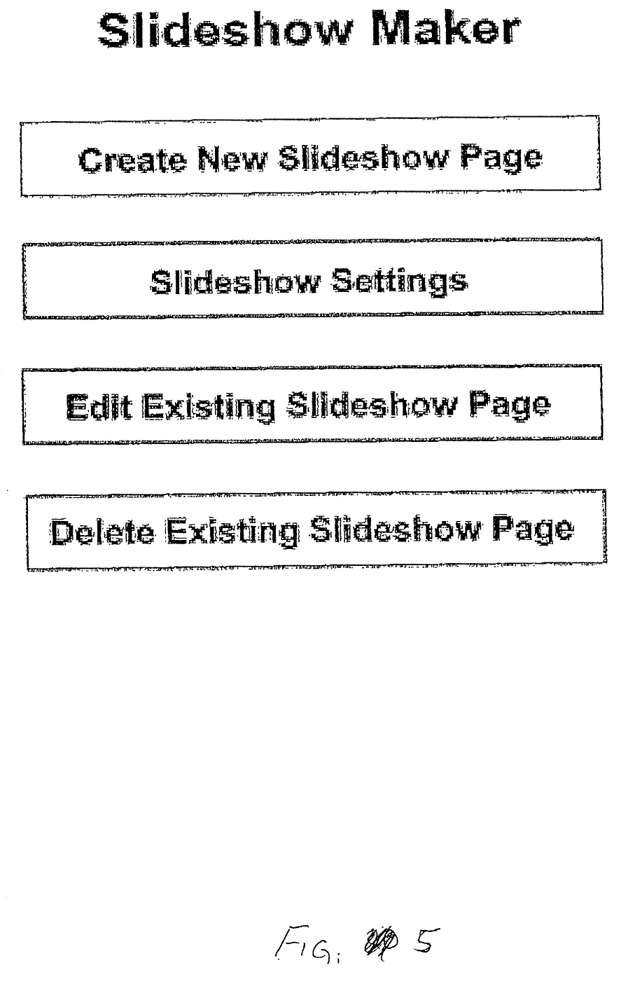

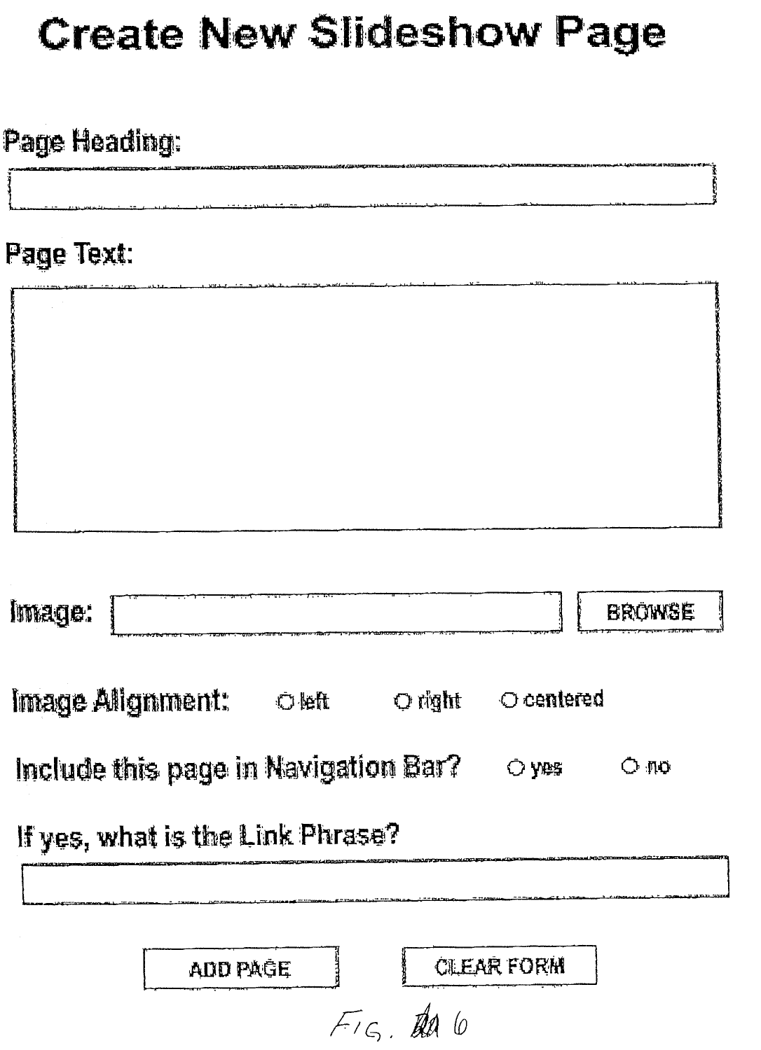

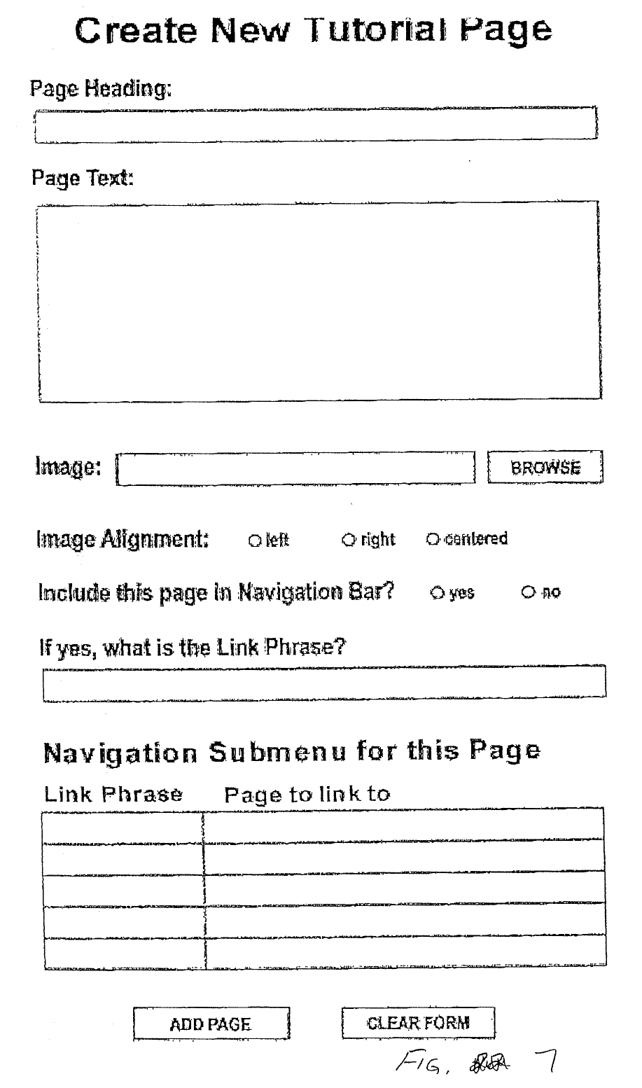

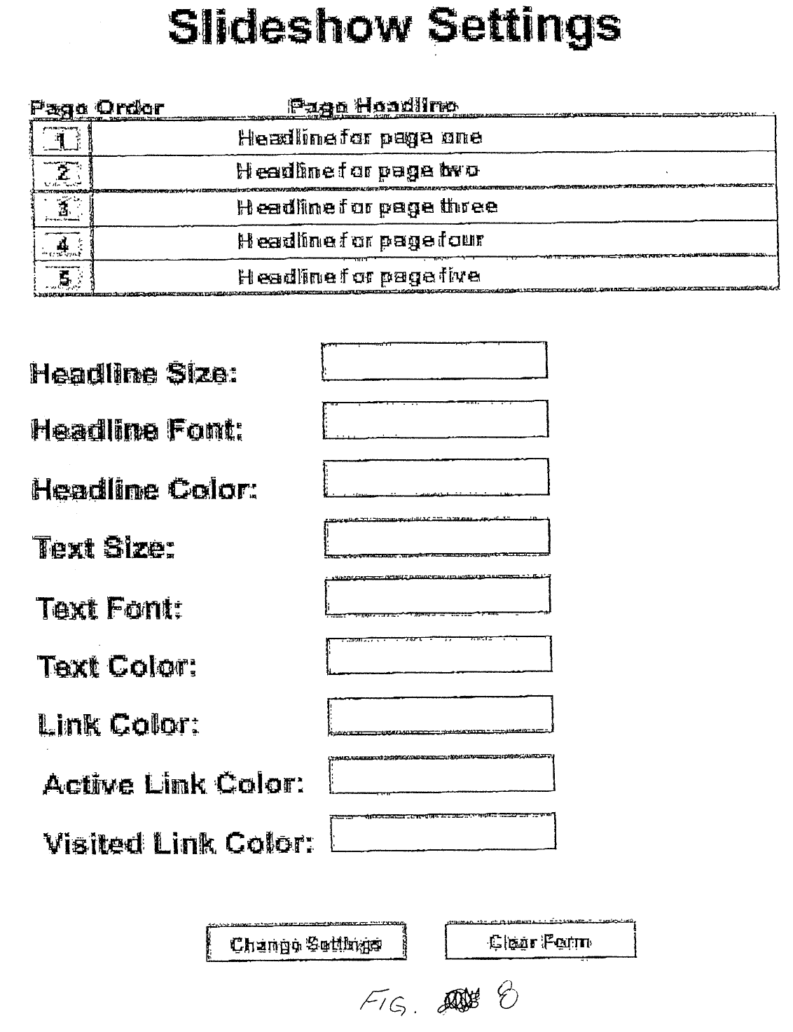

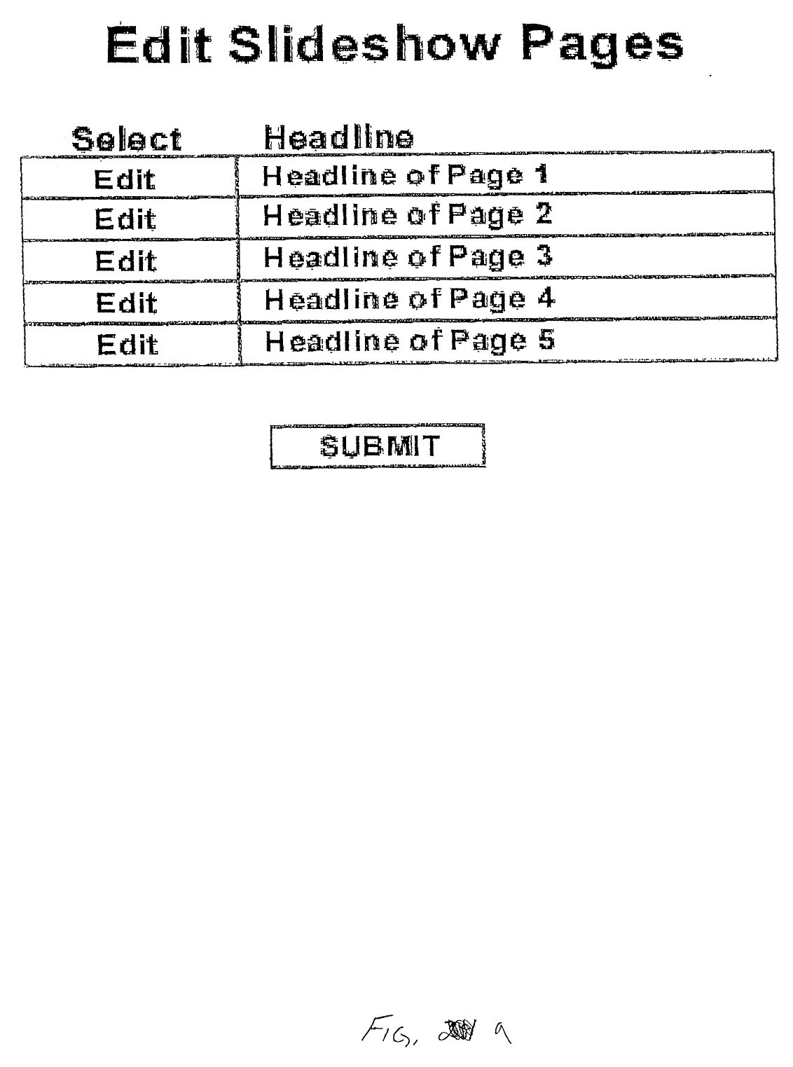

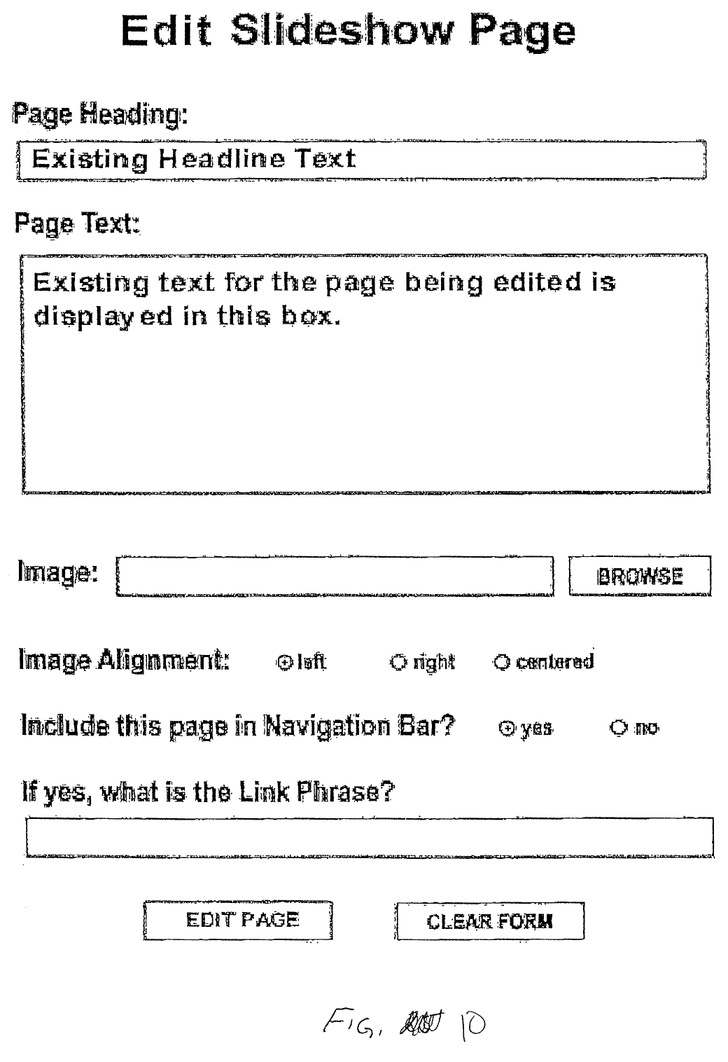

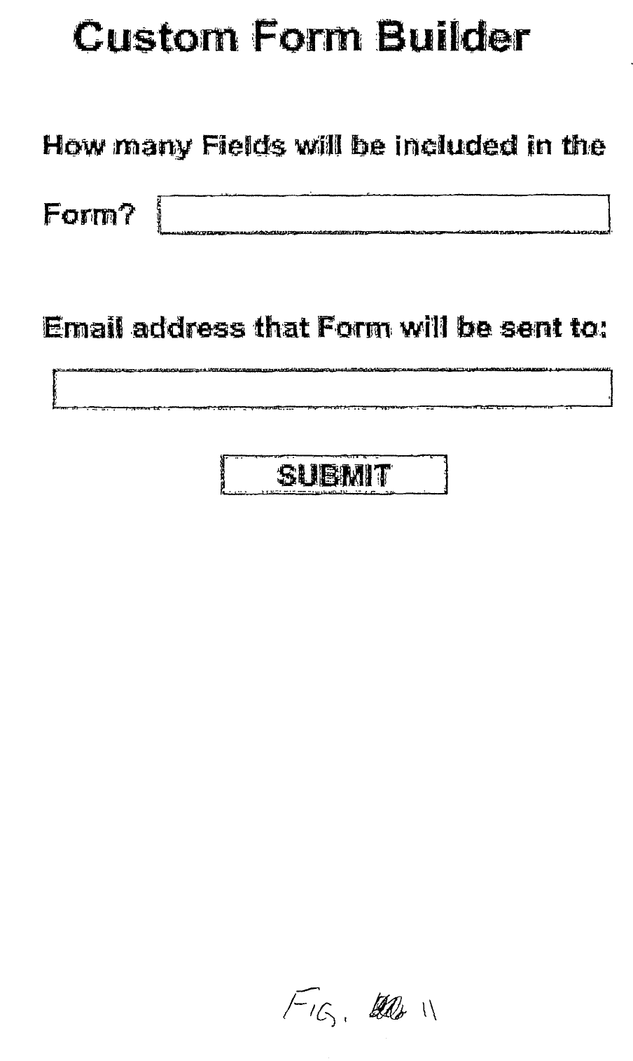

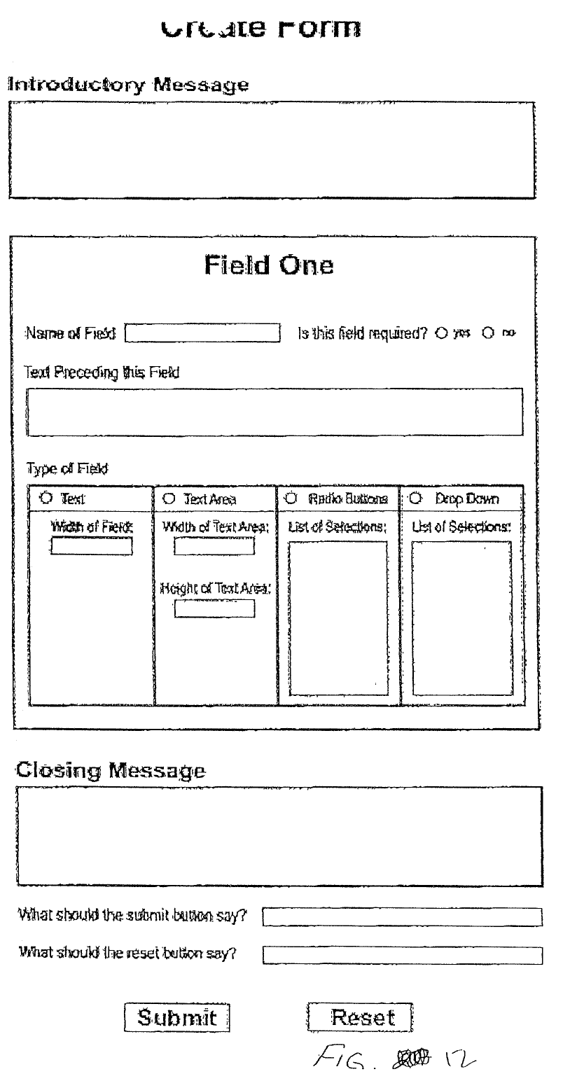

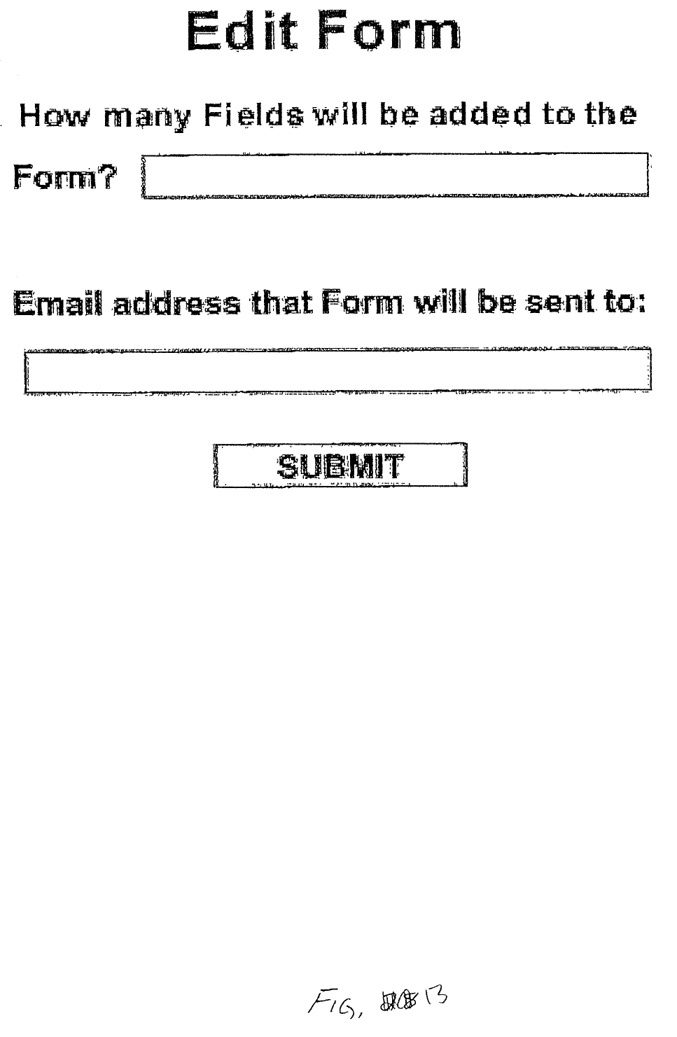

FIGS. 5-13 illustrate a preferred embodiment of the present invention for creating slideshows. The figures illustrate sequential steps a user can follow to create or edit the properties and operations of a slideshow. By way of example but not limited to, features included in the slideshow maker allow a user to create new slideshow pages, edit slideshow content, modify slideshow settings, and delete existing slideshow pages. Furthermore, the slideshow maker can be used to create custom forms and specify operations of fields within the created forms. Slideshow maker can also be used to create tutorial pages.

The present invention may be embodied in other specific forms without departing from its spirit or essential characteristics. The described embodiments herein should be deemed only as illustrative. Indeed, the appended claims indicate the scope of the invention; the description, being used for illustrative purposes, does not limit the scope of the invention. All variations that come within the meaning and range of equivalency of the claims are to be embraced within their scope.

What is claimed is:

1. A software tool for creating a user-specified electronic commerce Internet shopping web site, said software tool comprising:
a structure-form based software tool that allows a user to create said web site based upon information input into a series of forms controlled by a customizable menu system.

2. The software tool of claim 1, wherein said software tool allows a user to generate a product listings page, a product information page, and an order form page, each automatically generated based upon user input and linked to one another.

3. The software tool of claim 1, wherein said software provides for the creation of a main administration menu.

4. The software tool of claim 1, wherein software tool allows a user to access other information from a plurality of similar web site owners, said software allowing said user to upload said information to use on said user's web site to circumvent having the need for third party software.

5. The software tool of claim 1, wherein said software tool is capable of creating a fully customizable menu system.

6. The software tool of claim 2, wherein said software tool is capable of allowing a user to change, from said order form of said web site, the attributes and characteristics of a product, and to modify and supplement an order being ordered.

7. The software tool of claim 1, wherein said software tool allows said web site to communicate with other commercial and non-commercial web sites on the Internet.

8. The software tool of claim 1, wherein said software tool allows said user to create affiliate programs for their site.

9. The software tool of claim 1, further comprising a slideshow maker tool for creating presentations on said web site, said slideshow maker organizing and allowing for the modification of the pages comprising said web site.

10. The software tool of claim 8, wherein said slideshow maker features a creation panel comprising a main menu, a page for creating new pages, two pages for editing existing pages, and a page for reordering existing pages and changing the look of all said pages.

11. The software tool of claim 1, further comprising a shopping cart/order form hybrid.

12. The software tool of claim 1, further comprising a custom form builder that allows said user to set up fields and values in HTML format to create forms that accept input from anyone accessing said web site through the Internet.

13. The software tool of claim 1, further comprising a downloadable order history that allows anyone accessing said web site and placing an order thereon to view orders that have been received, and to provide several modification and cancellation options.

14. The software tool of claim 1, further comprising hidden web pages that said user may wish to be kept hidden.

15. The software tool of claim 1, further comprising the ability to create categories of user preference.

16. The software tool of claim 1, further comprising the ability to create button images that can be loaded onto a navigation bar, said button images uploadable as the button for a particular web page.

17. The software tool of claim 1, further comprising the ability to easily align logos to be used on said web site.

18. A software tool for creating a user-specified electronic commerce Internet web site, said software tool comprising:
means for creating said web site using a structure-form based software tool.

19. A method in a computer system for creating an e-commerce Internet web site, said method comprising the steps of:
generating a series of customizable web pages on said web site using a structure-form based software tool.

20. The method of claim 19, further comprising the step of generating a product listings page.

21. The method of claim 19, further comprising the step of generating a product information page.

22. The method of claim 19, further comprising the step of generating an order form page.

23. The method of claim 19, further comprising the step of generating a customizable menu administration page.

24. The method of claim 19, further comprising the step of creating an index to organize the information on said web site.

25. A computer-readable program product for creating an eCommerce Internet web site, said computer program product comprising:
code that directs a computer to create said web site using a structure-form based software tool that allows a user to input information into a series of forms controlled by a customizable menu system;
wherein said code resides on a tangible medium.

26. The computer-readable program product of claim 25, further comprising code that directs a computer to generate a product listings page.

27. The computer-readable program product of claim 25, further comprising code that directs a computer to generate a product information page.

28. The computer-readable program product of claim 25, further comprising code that directs a computer to generate an order form page.

29. The computer-readable program product of claim 25, further comprising code that directs a computer to generate an index for organizing said web site.

30. The computer-readable program product of claim 25, further comprising code that directs a computer to generate a slideshow maker for executing presentations.
